(19) United States
(12) Patent Application Publication
(10) Pub. No.: US 2012/0278185 A1
(43) Pub. Date: Nov. 1, 2012

(54) METHOD TO ADAPT ADS RENDERED IN A MOBILE DEVICE BASED ON EXISTENCE OF OTHER MOBILE APPLICATIONS

(76) Inventors: Vinod Kumar RAMACHANDRAN, Sunnyvale, CA (US); Dean Browne, San Carlos, CA (US)

(21) Appl. No.: 13/108,859

(22) Filed: May 16, 2011

Related U.S. Application Data
(60) Provisional application No. 61/481,204, filed on May 1, 2011.

(51) Int. Cl. G06Q 30/00; G06F 17/30; G06F 15/16

(52) U.S. Cl. 705/14.73; 709/219; 707/769; 709/203; 707/E17.108

(57) ABSTRACT

A method, apparatus and computer-readable storage medium for adapting alternative documents associated with content to be rendered in a mobile device is disclosed. A method, apparatus and computer-readable storage medium for adapting content, such as ads, based on presence or absence of certain mobile applications is disclosed. The mobile device performs receiving a group of contents together with condition code for each respective content. The mobile device checks a condition code, which includes examining the set of mobile applications contained in the mobile device, selecting and showing the content whose condition code specifying presence or absence of a set of mobile applications is met. A server computer is disclosed for serving a requested content based on checking a condition code. A client front-end is disclosed that enables specifying an ordered sequence of alternative documents or specifying conditions to be met in order to show respective content from a group.

### CROSS-REFERENCE TO RELATED APPLICATIONS

This application claims the benefit of U.S. Provisional Application No. 61/481,204 filed May 1, 2011. The entire contents of which are hereby incorporated by reference and for which priority is claimed under 35 U.S.C. §119(e).

### BACKGROUND OF THE INVENTION

### Technical Field

The inventive field relates to serving relevant virtual content to a user of a mobile device.

### SUMMARY

A method, a computer-readable storage device, and a mobile device processing a mobile application and a viewing component. The mobile application containing a virtual content handling component that is executed by the viewing component and that can access services of an operating system. The mobile application sending a request for a content to a server computer and receiving a content coupled with a condition code that can be handled by the viewing component and an ordered sequence of alternative document addresses. The virtual content handling component sending a request to the operating system to open a document listed in the ordered sequence of document addresses by executing the condition code. The operating system opening a document associated with the content whose condition specified in the condition code is met. The viewing component obtaining another document different from the first document when the condition is not met. The viewing component showing the respective document in accordance with the results of executing the condition code.

A method, a computer-readable storage device, and a mobile device processing one or more mobile applications and a viewing component. At least one of the mobile applications containing a virtual content handling component that that can access services of an operating system. The mobile device having a memory storing the one or more mobile applications, the virtual content handling component is capable of accessing a list of registered one or more mobile applications stored in the memory. The mobile device sending a request for a content to a server computer, The virtual content handling component receiving as a response to the request, a group of two or more contents together with condition codes for respective contents. The condition codes being a test of a condition that certain mobile applications be present or absent in the mobile device. The virtual content handling component sending a request to the operating system to execute a condition code of the received condition codes and receiving a response to the condition. The virtual content handling component continues to send requests to execute condition code to the operating system until a condition in a condition code is met. The content whose condition code is met is provided to the viewing component.

A method and a server computer in communication with a virtual content database system, the server computer including a virtual content selection component, and a memory. The server computer receiving a content and an ordered sequence of document addresses and storing the content in association with the sequence of document addresses in the virtual content database. The server computer receiving a request for a content from a mobile device, selecting a content from the virtual content database, the selected content being the content received, and sending to the mobile device, as a response to the request for content, the selected content and the ordered sequence of document addresses expressed in the form of a condition code.

A method and a server computer in communication with a content database system, the server computer including virtual content selection component and a memory. The server computer receiving a group of two or more contents and conditions associated with the contents. A condition being a condition for showing a respective content of the group of two or more contents, including a condition of the presence or absence of mobile applications in a particular mobile device. The server computer storing the received group of two or more contents and respective conditions in the content database. The server computer receiving a request for a content from a mobile device. The sever computer selecting a content group from the content database, the content group being the two or more contents received, and sending to the mobile device, as a response to the request for content, the selected group of two or more contents and the respective conditions expressed in the form of condition code.

### BRIEF DESCRIPTION OF THE DRAWINGS

FIG. 1 is a block diagram of a mobile device;

FIG. 2 is a flowchart for a waterfall-type ad serving process;

FIG. 3 is a flowchart for an adaptive-type ad serving process;

FIG. 4 is a flowchart for a general conditional ad serving process;

FIG. 5 is a system diagram for an example network system;

FIG. 6 is a data flow diagram that corresponds to the flowchart in FIG. 2;

FIG. 7 is a data flow diagram that corresponds to the flowchart in FIG. 3;

FIG. 8 is a data flow diagram that corresponds to the flowchart in FIG. 4;

FIG. 9 is a flowchart for ad server operations related to operations shown in FIG. 6;

FIG. 10 is a flowchart for ad server operations related to operations shown in FIGS. 7 and 8;

FIG. 11 illustrates an example user interface for an advertiser front-end related to the operations shown in FIG. 6;

FIG. 12 illustrates an example user interface for an advertiser front-end related to the operations shown in FIGS. 7 and 8;

FIG. 13 illustrates an example user interface for an advertiser front-end that is a result of a link from the user interface of FIG. 12; and

FIG. 14 is a block diagram of an example of an ad server computer.

### DETAILED DESCRIPTION

Mobile applications (mobile apps) have become very popular and many mobile app developers have a need for mechanisms that enable them to promote their apps through advertisements (ads or other virtual content). Mobile app developers have a need for a mechanism that would enable them to show an ad or other virtual content in a mobile device that can provide alternative paths to the mobile app developers own advertisement app. Mobile app developers, publishers and other advertisers have a need for a mechanism that would enable them to present an ad or other virtual content appropriate for the set of mobile apps present or absent on a mobile device.

Advertisers have a need for a mechanism that enables specification of a condition that ensures that the advertiser's own app or a page within that advertiser's app (e.g., Hotel Search page) is opened when a user clicks on their ad or other virtual content. Advertiser's have a need for a mechanism that enables specifying a condition that checks whether the advertiser's own app does exist, or a directs a user to a web page of the advertiser if the advertiser's app does not exist.

As another aspect, a book publisher can publish electronic books for a growing number of reader devices and reader apps. A developer of a reader app has a need for a mechanism that enables showing an ad that can be used to take a user of the reader app to an advertisement app associated with the ad, or a web site or store to obtain the advertisement app, if it does not exist on the mobile device. A conventional approach has been for the advertiser to decide a priori whether the user would be taken to the app, the web page, or store. A problem with this approach has been that if the advertiser had chosen the user to be taken to the app, but a user has not downloaded the app, then clicking on the ad will not initiate any further action. Also, in the case that an advertiser may be charged per click, the click on the ad may result in a charge to the advertiser even if there is no further action.

When a book publisher wishes to advertise a book, the book publisher has a need for a mechanism that can be used to send ads or other virtual content for the book that take into consideration the presence or absence of apps on the mobile device. For example, a book publisher may need a mechanism that enables checking for the presence of other reading apps and the absence of a particular reading app of interest to the book before rendering an ad or other virtual content for the new book. Book publishers have a need for a mechanism that enables them to send a number of different ads, each ad being for a different condition, such as presence of certain apps. An ad or other virtual content whose respective condition is met can be chosen for display.

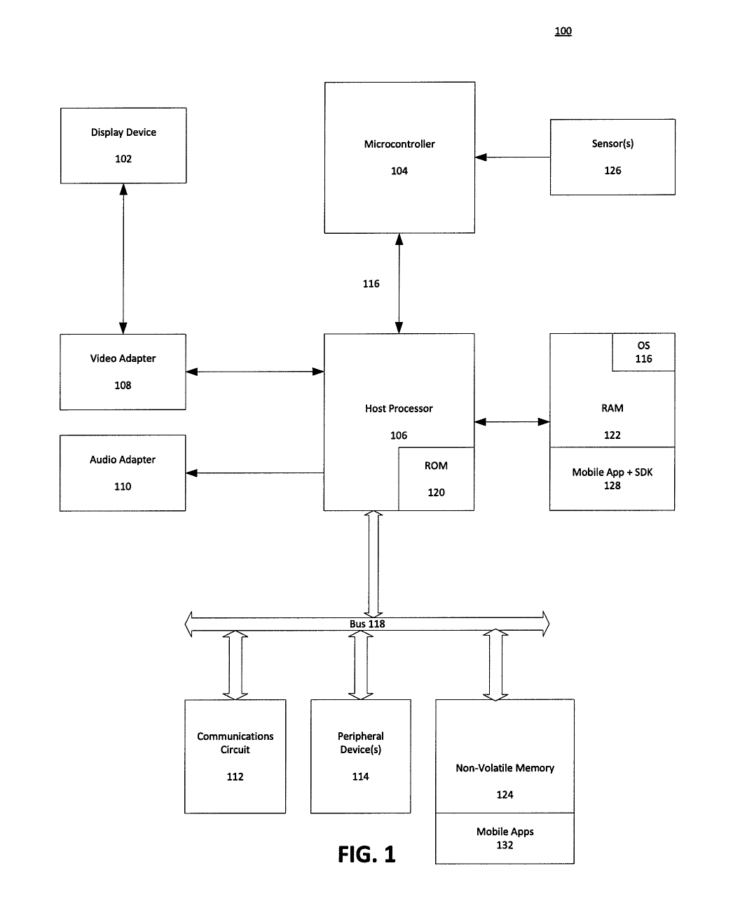

FIG. 1 is a block diagram for a mobile device 100. The mobile device 100 typically includes a microcontroller 104 that is in communication with a host processor 106 by way of a bus 116. The microcontroller 104 processes signals from sensors 126, such as an accelerometer, a gyroscope, and proximity sensor. The host processor 106 can transmit data to a communications circuit 112, which provides external communication.

In addition, the host processor 106 can operate in conjunction with a video adapter 108 for display on a display device 102, and can operate in conjunction with audio device 110. A principal bus 118 provides communications between the host processor 106 and peripheral devices 114.

The host processor 106 works with programs maintained in a ROM 120 and performs processing using a RAM 122. In addition, as will be discussed later, the host processor 106 may have access to applications and data stored in non-volatile memory 124, such as built-in EEPROM, and removable large capacity storage devices 114, such as microSD, microSDHC, or removable EEPROM devices (connectable through an external bus, such as USB). The non-volatile memory 124 typically stores one or more mobile applications 132.

Mobile applications (Apps) may be downloaded onto a mobile device 100, and include many different categories of applications, including games, and various information providing utilities. Developers of mobile apps (or publishers) can integrate advertising software that enables the mobile app to request ads from a server computer for display in the app. Under normal operation, when an app which is integrated with the advertising software is invoked, the advertising software sends an ad request to an ad server. The ad server returns the “best” ad(s) based on various parameters, including relevance and bid amount.

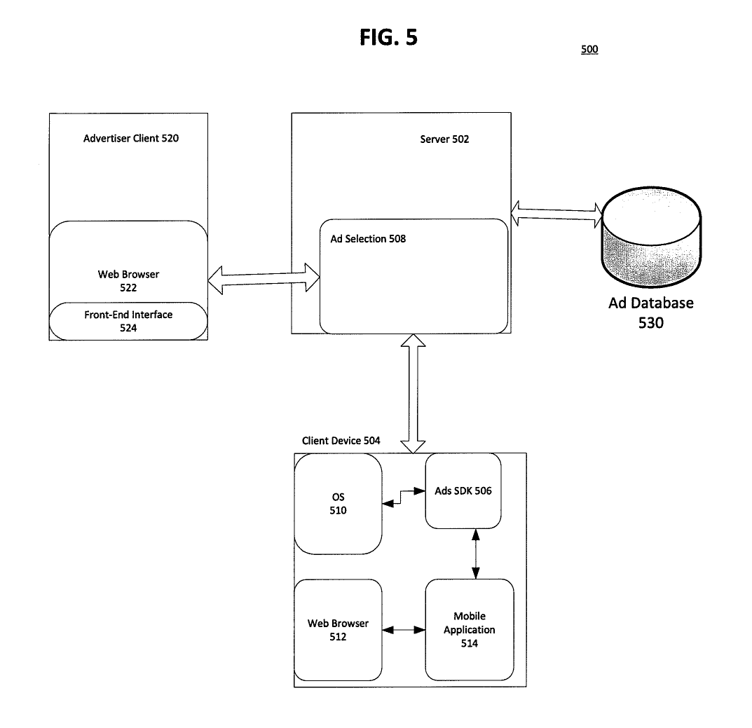

FIG. 5 is a system diagram for an example network system. A mobile device 100 may be a client device 504 that is in communication with a server 502, which can be an ad server. An advertiser client 520 may also be in communication with ad server 502. It is noted that for purposes of this disclosure, an ad provided by a server can alternatively be virtual content.

The ad server 502 includes an ad selection component 508 that can retrieve ads from an ad database 530 in response to a request for an ad from the client device 504, and transmit a selected ad to the client device 504. Ad selection by the Ad selection component 508 may be in accordance with an ad auction.

An app developer can incorporate advertising software in a mobile app for requesting ads or other virtual content from the server 502. The advertising software can include an ads software development kit (SDK) 506 that is capable of receiving one or more ads and condition code, rendering the ad on the client device 504, querying the OS 510 to open an app, and handling condition code, such as JavaScript, to enable checking alternative paths to an appropriate app or page, or check for presence of absence of apps. The client device 504 includes a Web browser and/or an other viewer component 512 and one or more mobile applications 514. Other viewer components can include, but are not limited to, animation, video and/or audio players, or embedded viewers for HTML documents such as WebView or UIWebView.

The advertiser client 520 can include a Web browser 522 or other client software capable of communications over a network. The Web browser 522 can display an advertiser front-end 524 for entry of ad creatives, addresses such as URL's for landing pages (or other documents) associated with an ad creative, and information of conditions for showing ads.

It is understood that although the drawing shows one each of a client device 504, server 502, Web browser 512 and mobile application 514, an example implementation may have more than one of each of these components. It is also understood that a mobile device 100, as client device 504 may include specific communications capability for cellular communications. In addition, the server 502 can be a server system having several server computers, as well as include back-end database servers.

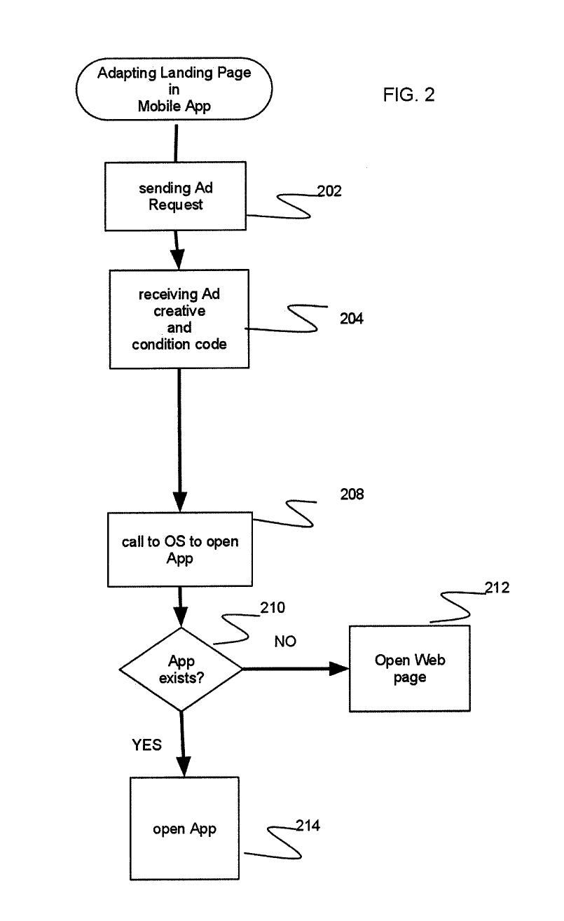

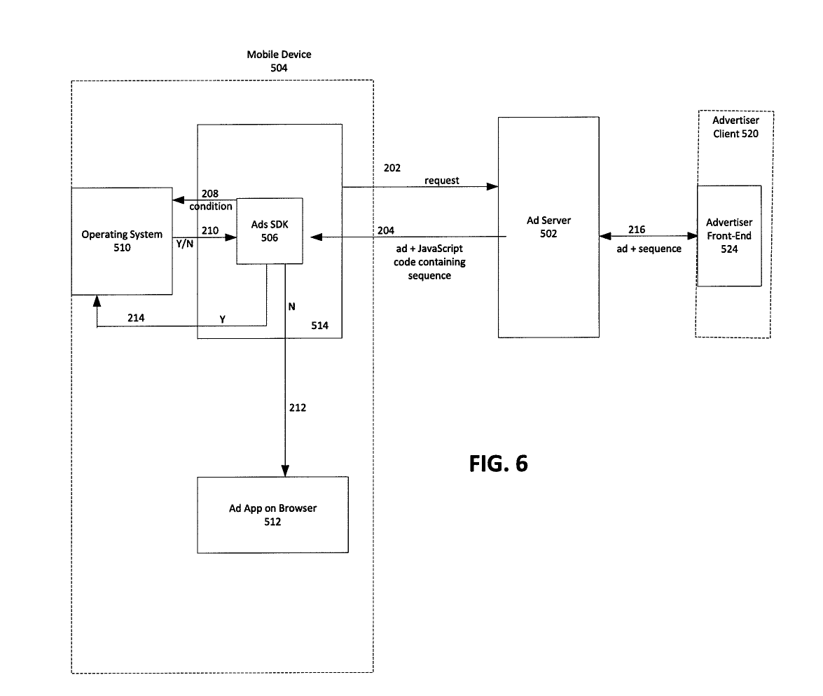

FIG. 2 is a flowchart for a waterfall-type ad serving process for a mobile device (FIG. 1, FIG. 5, client device 504). FIG. 6 is a corresponding data flow diagram. In a case that an app for an advertiser (advertiser app) has not been installed in a mobile device 100, an advertiser's mobile ad or other virtual content may receive a click, and a condition code can be checked providing a mechanism for adapting the landing page (or other document) for an ad.

A mobile app, such as a game (FIG. 5, mobile application 514), can be incorporated with advertising software for obtaining a mobile ad or other virtual content. At step 202, the advertising software sends a request for an ad to a server computer (see FIG. 5, server 502). The server computer selects an ad or other virtual content from ad database 530 using an ad selection component (FIG. 5, ad selection component 508).

Ads maintained in ad database 530 can be submitted by advertisers, by way of an advertiser client device 520 for submitting mobile ads. The client device for submitting mobile ads is typically a device being used by an advertiser, which is a different client from a mobile device of an end-user. However, it is understood that an end-user mobile device 504 may be used by an advertiser to develop a creative and submit the creative to the ad server 502. An advertiser may design a creative or creatives as part of an advertisement campaign. The advertiser's client device 520 includes a Web browser 522 that can render an advertiser front-end 524 that facilitates input of a creative and an ordered sequence of landing page addresses associated with the creative, in an order that an advertiser wishes them to be considered by a mobile device. Landing page addresses can be pre-registered addresses, such as Uniform Resource Locators (URL's) for each landing page (or other document).

The ad server 502 can receive from the advertising client 520 a creative and an associated ordered sequential list of landing page (or other documents) addresses. The ad server 502 then generates code that will enable a mobile device to process the ordered sequential list of landing page (or other documents) addresses. The code is in the form of a conditional logic code, which may be expressed in a scripting language such as JavaScript. Some aspects of a creative can use features supported by the most current version of HTML, enabling less code or eliminating a need for plug-in code. A current widely available version of HTML is HTML 5. As an alternative, an advertiser can choose to create code, such as JavaScript, using the advertising client 520 and submit the conditional logic code together with an ad creative to the ad server 502.

At step 204, the ads SDK 506 receives from the ad server 502 a selected ad creative together with parameters, including conditional logic code.

The mobile app having the incorporated advertising software can show an ad or other virtual content, for example related to a particular television product. The conditional logic code included with the ad is to be executed when the ad is received. The conditional logic code can specify that the ordered sequential list of landing page (or other document) addresses that were originally provided by an advertiser, be considered in the specified order. Processing of the conditional logic code can be performed by a viewer component capable of handling the conditional logic code, such as JavaScript, or can be submitted for processing by the operating system through an instruction in the ads SDK 506.

As an example, an advertiser may have provided an ordered list of apps, such that an app associated with the advertiser is listed first to be considered for a requested landing page, if it is present on a mobile device. If the advertiser's app is not present on the mobile device, an external landing page is opened that was indicated as second in the ordered list, or an app store is opened, that was indicated as third, having instructions for downloading the advertiser's app.

At step 208, the ads SDK 506 will query the OS 510 and, at step 210, depending on the conditional logic code, determine if a mobile app for the advertiser is stored on the device. If the mobile app for the advertiser is present, then, at step 214, a click on the ad will open the advertiser's app. When the advertiser's app is opened, the advertiser app can display a page with more details, such as details on that particular television. If the advertiser's app does not exist, then, at step 212, the App Store will open to allow for downloading of the advertiser's app or the advertiser's Web page may be opened in a mobile Web browser (FIG. 5, Web browser 512).

Alternatively, an advertiser may have specified that an app store be opened to obtain the latest version of the advertiser's product or service, and only if the mobile device could not handle the latest version of a product a local landing page be opened on the mobile device. Other orderings of landing page addresses are possible. The number of landing page addresses and the ordering of landing page address consideration can vary within the capability of the scripting language used for describing the conditional logic code.

Provided a structure in which conditional logic code, such as JavaScript code is included with the ad, and a SDK 506 that is capable of querying the OS 510 to check a condition and to open the appropriate app and page, the mobile device 504 is capable of showing ads or other virtual content in a manner that is most desirable for advertisers. The mechanism allows adaptive processing as a result of a user click on an ad in the form of a waterfall of events. In addition, processing of the advertisers app or advertisers Web page can be handled by native code incorporated in the SDK 506.

In a further aspect, in a case where there is an ad for an advertiser with URL A, but an app for an advertiser's product or service is not installed, at step 212, the ads SDK 506 instructs the opening of the App Store URL B to enable installation of the advertiser's app. In this example aspect, the advertiser's app can open directly to page A after the advertiser's app is installed through URL B. According to this further aspect, if the ad was, for example, for a trip to Hawaii that the user requested, the user would be provided with that trip. Without the further aspect, if the user just started the advertiser's app for the first time, the user would have to re-initiate the search for Hawaii, which will reduce the conversion rate for the ad. The further aspect can be accomplished by having the advertiser's software store parameters associated with the ad just prior to the point where the app store is opened. Then, when the advertiser's app is downloaded from the app store and installed, the installed app determines a relevant page to open based on the stored parameters.

In an example aspect, the ad may indicate that it was clicked on by device ID X for the advertiser's app. If the advertiser's app was opened within some time window—for example 24 hours—the advertiser could check with the ad server to determine if device ID X came from an ad click and what the original URL was for. In the above-mentioned example, the URL A and the advertiser's app would be used to go immediately to the Hawaii search. In addition, in order to maintain user privacy, a hashed and anonymized device identifier can be used rather than the device ID.

In another example aspect, the ads SDK 506 can be notified when an installation operation has been performed by way of receiving a “referrer” string from the ad. The “referrer” string can be immediately stored on the client device 504. When the user opens the app, a cached URL A on the client device 504 and the app can be accessed, without the need to check with the ad server 502.

A further aspect is adapting the ad itself based on the presence or absence of other apps.

Depending on the type of mobile platform (e.g., operating system and mobile device), each mobile app or activity within that app registers itself with the operating system. An advertiser's app may have registered to accept URLs like “blah-blah://”. The operating system (OS) can detect if the advertiser's app can open the URL by calling a function to open a URL and if it returns true, the Advertiser's app can be handled. Provided this operation, the ads SDK can query the OS, which can maintain a list of registered apps, and determine whether an app or the activity is present or not.

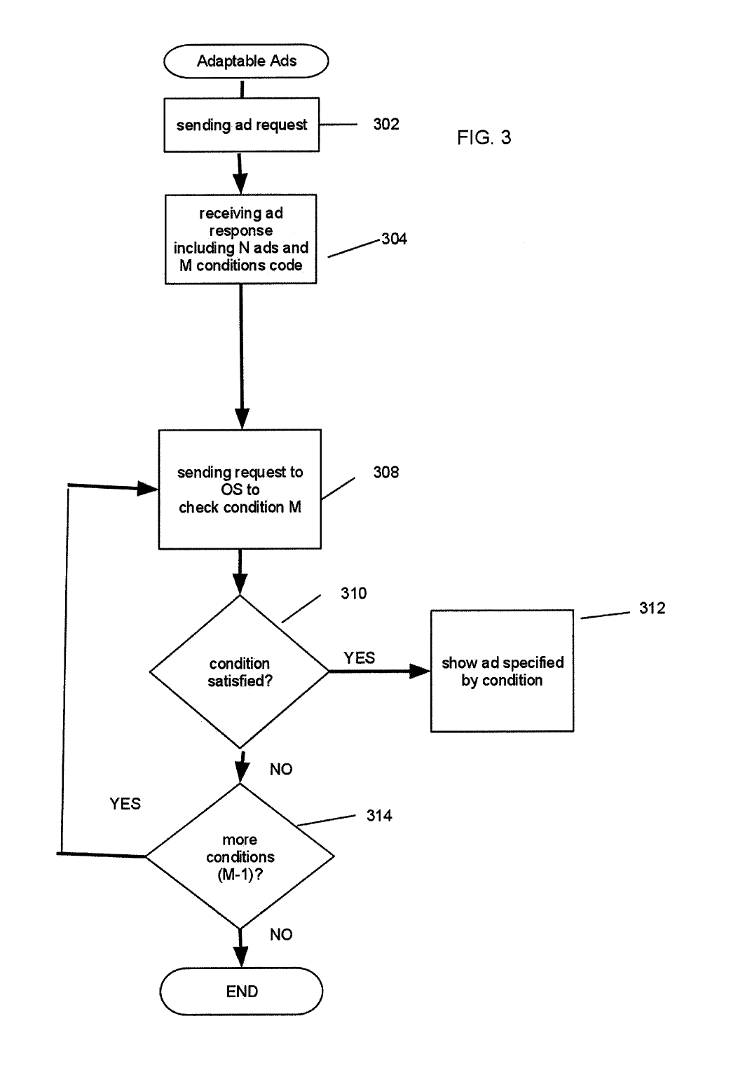

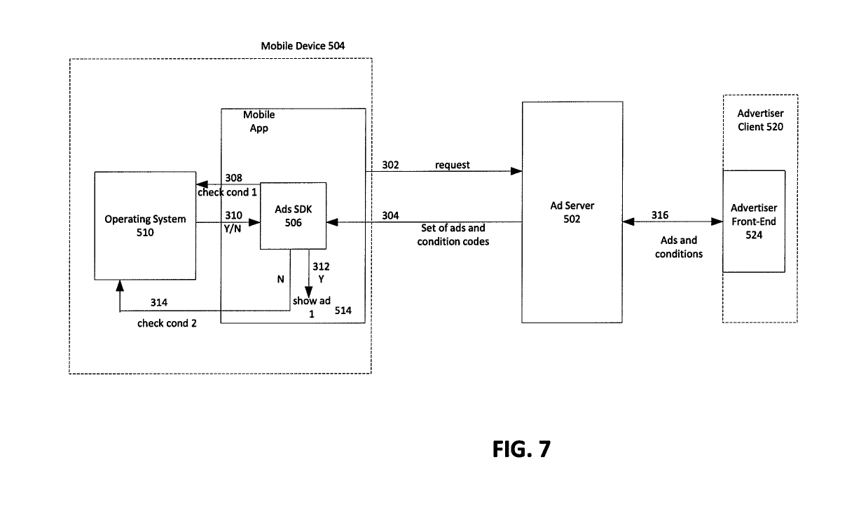

An app developer may want to promote its portfolio of apps through ads. For example, a book publisher may want to distribute different ads depending on the apps that present and/or absent on the mobile device. An advertiser's selectable set of ads for a product or service is referred to as an adaptive ad. FIG. 3 shows an example of adaptive ads. FIG. 7 shows a corresponding data flow diagram.

An advertiser, such as the book publisher, can create a set of ads using tools provided at an advertiser client computer 520. An advertiser front end 524 provides an interface for submitting a set of ads, as well as conditions to show the ads. For example the book publisher can create an ad for a book for each type of reader app, or for a particular reader app, and upload a set of ads and associated conditions. A condition can be that, if a mobile device has a reader app, show an ad for that type of reader app. As an other example, a condition can be that, if a mobile device has a group of apps of a certain type but an app for which the book is formatted for is absent, do not show an ad for a book that requires the particular reading app.

In step 302, an ad request is sent to the ad server 502, and, at step 304, the ad server 502 selects an ad for the app developer to show. The ad response can contain multiple (N) creatives (or links to the creatives) and the links to the respective landing pages. In addition, the ad response can include JavaScript code having multiple (M) conditions.

The multiple ad creatives and links to respective landing pages that are maintained by the ad server 502, can have been submitted by an advertiser using advertiser front-end 524 on an advertiser client device 520.

At step 308, the ads SDK 506 can send a request to the OS 510 to check the first condition M. At step 310, if the condition is satisfied, at step 312 an ad that meets the condition can be provided to the client device 504 for display. If the first condition is not satisfied, at step 314, more conditions are checked. In an example aspect, the JavaScript code of the ad, at step 308, can instruct the ads SDK to detect which apps of the app developer exists in the device and then pick the creative corresponding to the app or set of apps that exist on the mobile device 504.

In a further aspect, the ads SDK 506 may also test different conditions before determining which exact creative is to be shown. For example, the advertiser may believe that if the client device 504 has App A and App C (e.g., both are games-related apps), then the user is likely to download App B (also a games-related app). JavaScript included in an ad can specify a list of conditions. The ads SDK 506 will then render the appropriate creative which may result in opening the App Store to enable App B to be downloaded when there is a click on the ad.

The ad server 502 can require that an app developer win an auction at the ad server 502 first without any information on the apps present at the client and then send multiple options to the client. Alternatively, the ad server may return more than one winner (each with multiple creatives) and there can be a mini-auction at the mobile device 504 based on the information detected at the device. For example, another app developer can bid a higher value than the initial app developer if it is determined that the user is already using one or more of the initial app developer's apps.

The example aspect shown in FIGS. 3 and 7 may include submitting JavaScript code for conditions and a set of ads to the mobile device 504, and reporting by the operating system 510 a set of apps contained in the mobile device 504 to the advertiser software. As an alternative, the advertiser software can send a list of ads present on the mobile device 504, together with the ad request, to the ad server 502. The ad server 502 can make a determination as to whether the set of apps for a particular mobile device 504 have been previously received at the ad server 502, or not, in determining the type of response to send to the mobile device 504.

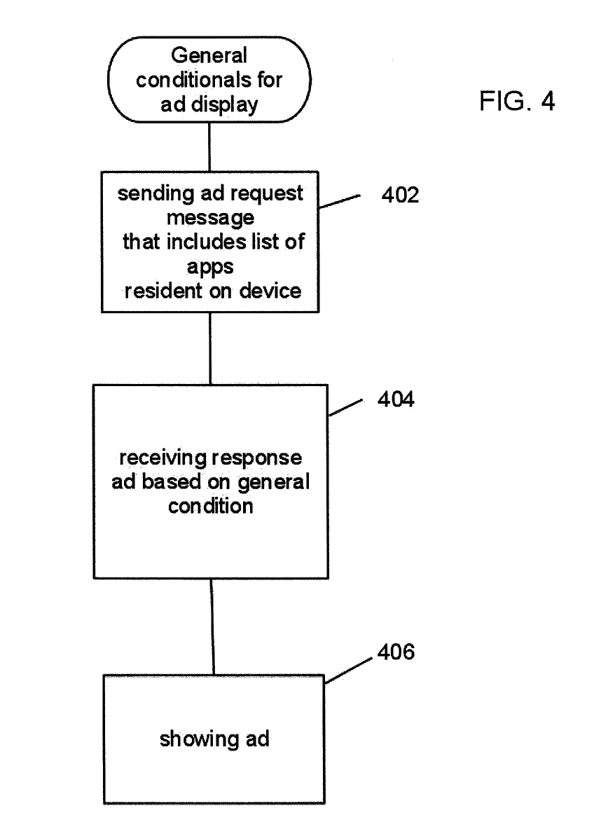

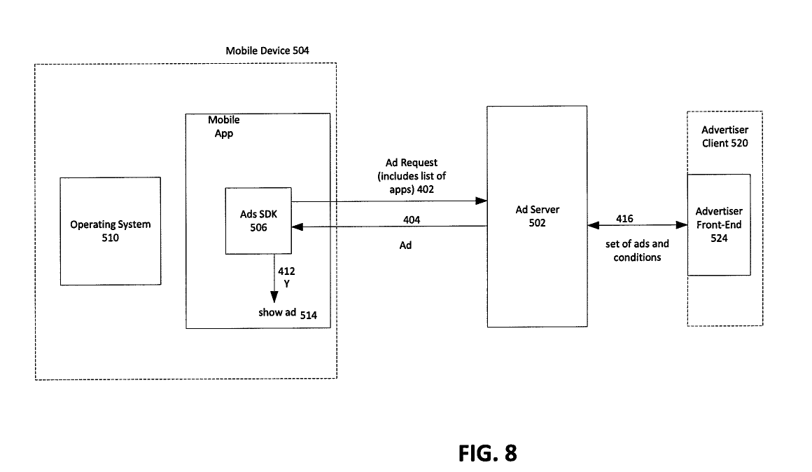

FIG. 4 shows a flowchart for a case in which the ad server 502 has been made aware of apps that are contained in the particular mobile device 504. FIG. 8 shows a corresponding data flow diagram. In step 402, an ad request from the client device 504 contains information on all or subset of apps present in the device. This can be accomplished by appending the application identifiers to the ad request.

Also, the ad server 502 can take information on which apps are present into account while determining the winner ad. For example, an app developer may be willing to bid higher if it knows that the mobile device already has three of its apps (i.e., a loyal customer). This aspect is provided when the ad server supports condition-based bids. At step 404, the ad server 502 may then respond with the exact ad (and the exact landing page) to be rendered, at step 406, on the client device 504. This aspect takes into consideration a trade-off between the above two aspects in terms of information transmitted over the air and the relevance of the ad itself.

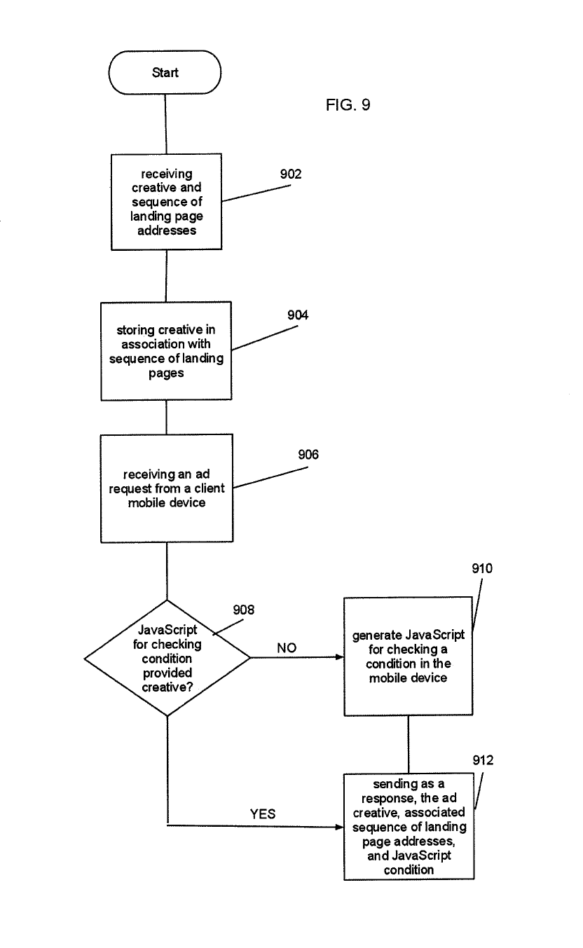

As indicated above, an ad server 502 may store ad creatives from advertisers in an ad database 530, and perform an auction to select ads from the ad database 530 in order to serve ads to requesting mobile devices. FIG. 9 is a flowchart for an example operation of the ad server 502. The example operation of the ad server 502 corresponds to the operations shown in data flow diagram of FIG. 6.

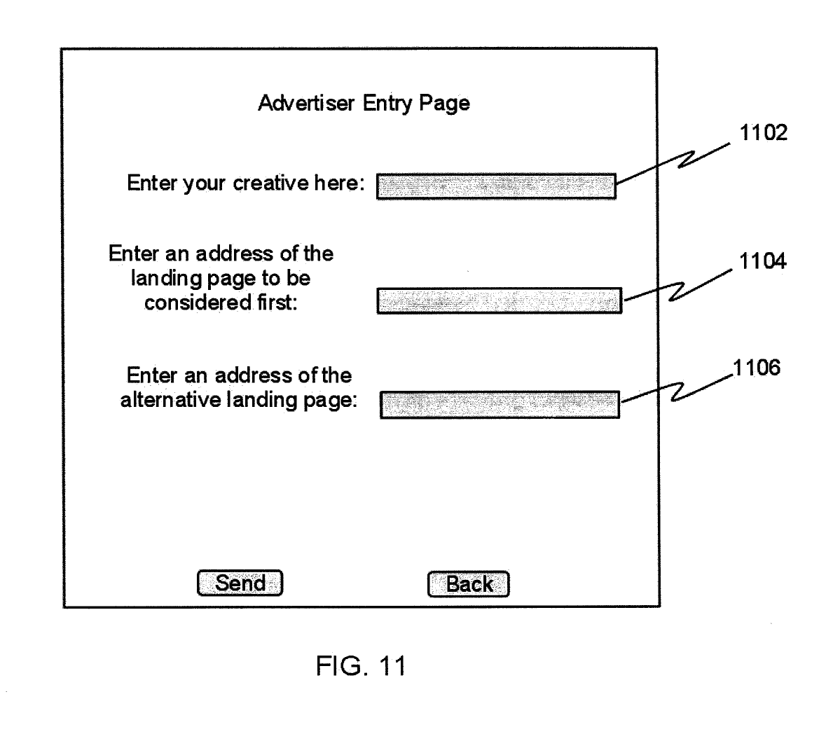

At step 902, the ad server 502 receives an ad creative from an advertiser, together with an associated sequence of landing pages. FIG. 11 shows an example of an advertiser's front-end 524 as rendered in Web browser 522 of the Advertiser client device 520. As can be seen in FIG. 11, the advertiser front-end 524 provides an input form in which an advertiser can enter at slot 1102 the name of a creative to be uploaded. The name of the creative can be a file name. The file name can be entered by browsing the advertiser client device in order to select a file stored in the device memory. The input form also provides slots for entry of an ordered sequence of addresses for a landing pages, for example a slot 1104 for entry of a landing page address to be considered first and a slot 1106 for entry of an alternative landing page, that are associated with the ad creative. An address of a landing page can be the URL of the advertiser's Web site, or page within the Web site containing information about a particular product or service that is the subject of the ad creative. An address of a landing page can also be the URL of an advertiser's app stored locally on an end-user's mobile device 504.

At step 904, the ad server 502 stores the ad creative received at step 902 in association with the received ordered sequence of landing pages addresses in ad database 530. At a later point, at step 906, the ad server 502 will receive an ad request from a client mobile device, at which time the ad server 502 will conduct an auction and may select the creative having the associated ordered sequence of landing page addresses.

The advertiser may submit conditional code, in the form of for example JavaScript and HTML, necessary for processing of the condition for determining which landing page address to be used in obtaining a landing page. Alternatively, the ad server 502 can generate the necessary condition code based on the order of landing pages. At step 908, the ad server 502 checks whether a condition code, such as a JavaScript condition code, has been provided by the advertiser. If the advertiser has not submitted condition code, at step 910, the ad server 502 will generate a JavaScript condition code for use in processing of a condition for determining which of a plurality of landing page addresses will be used for showing a landing page. At step 912, the ad server 502 will send a response to the ad request, that includes the ad creative, associated list of landing page addresses, and JavaScript condition code.

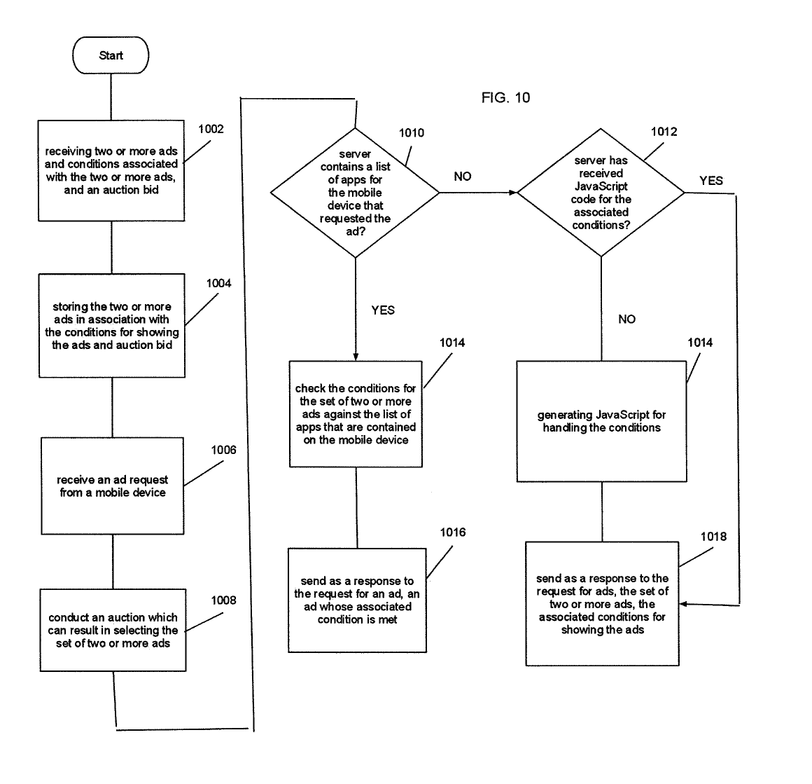

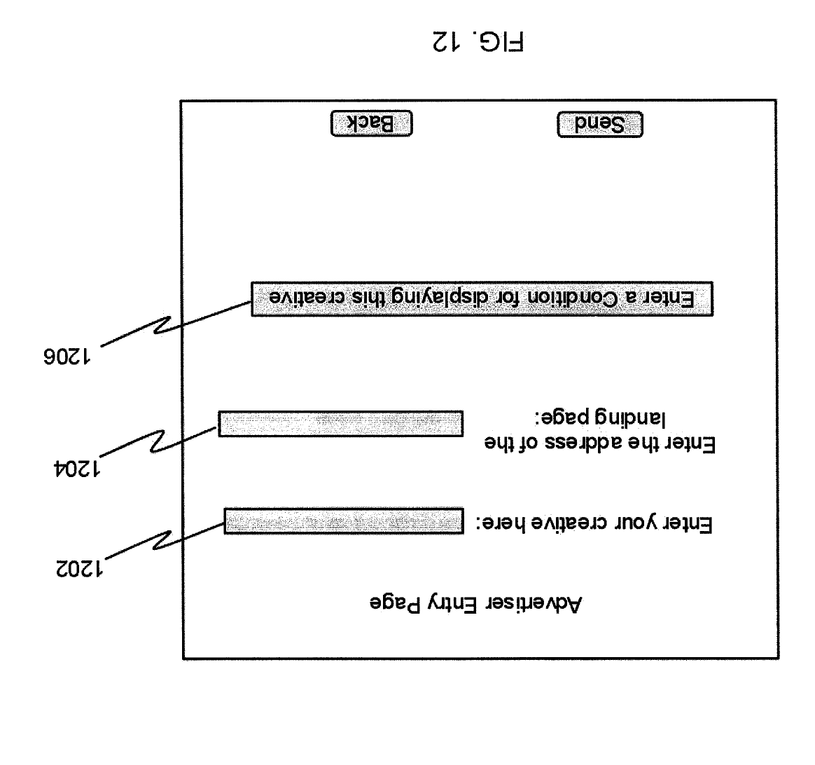

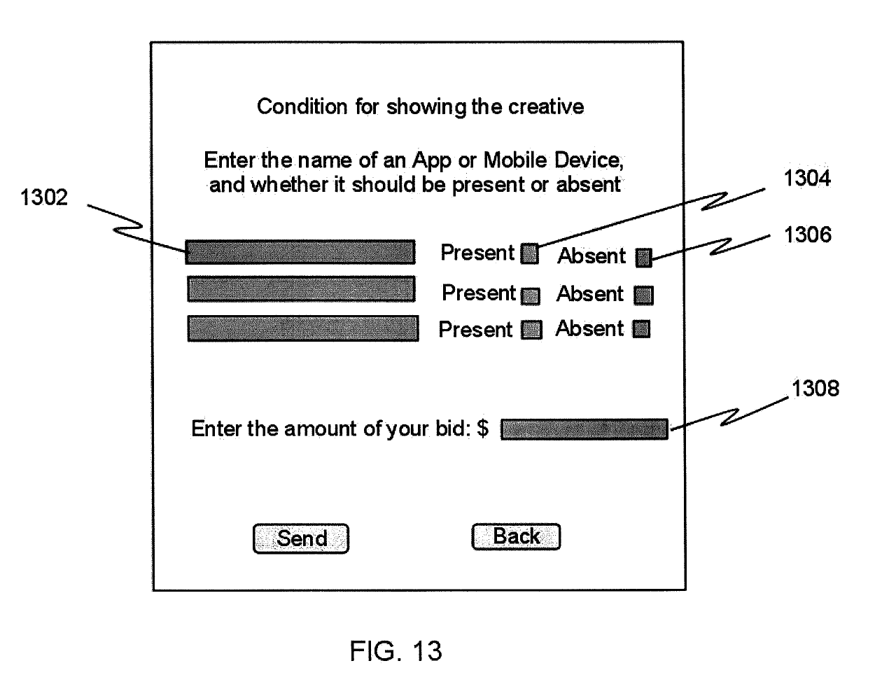

In a further aspect described above with respect to FIGS. 3, 4, 7 and 8, an advertiser can submit a set of ad creatives so that an ad creative that is appropriate for a particular mobile device/OS and existing apps on the particular mobile device can be selected to be shown. FIG. 10 is a flowchart for operations performed by the ad server 502 in a case where an advertiser submits a set of two or more ad creatives. FIGS. 12 and 13 are examples of user interfaces for an advertiser front-end 524.

At step 1002, the ad server 502 receives two or more ad creatives, conditions associated with the two or more ad creatives, and an auction bid for the ad creatives. FIG. 12 shows an example user interface that enables an advertiser to enter a name of an ad creative in slot 1202, and address of an associated landing page in slot 1204, and a link 1206 to another page which can be used to enter a condition for displaying the ad creative. FIG. 13 shows an example of the page for entry of a condition associated with an ad creative. The name of the ad creative can be entered as a file name, and the file name can be accessed by browsing the advertiser client's 520 memory. The ad creative entry page may be repeated for each ad creative that the advertiser wishes to enter. In an example aspect, all ad creatives entered by the advertiser can be submitted to the ad server as a common session in order to group the ad creatives into a related set.

The page for entry of a condition as shown in FIG. 13, includes slots 1302 for entering mobile apps, and check boxes 1304 and 1306 for indicating whether the mobile apps should be present or absent. For example, an advertiser may indicate that a mobile app A and a mobile app B each should be present, as a condition for showing the ad creative associated with this condition. The page shown in FIG. 13 further includes an entry slot 1308 for entering a bid amount that the advertiser is willing to bid for a set of ad creatives that include conditions for selecting an ad creative.

At step 1004, the ad server 502 stores the two or more ad creatives in association with the conditions and auction bid that had been submitted in a session with the advertiser client 520 in ad database 530. At a later time, at step 1006, the ad server 502 will receive a request for an ad from a mobile device 504. The ad server will conduct an auction which can result in selection of the set of two or more ad creatives received from the advertiser client 520.

As shown in FIG. 8, an ad server 502 may have received a list of mobile apps that are contained on the particular mobile device that submitted the ad request. At step 1010, the ad server checks if a list of mobile apps contained on the particular mobile device had been submitted along with the ad request. If a list of mobile apps had been sent by the mobile device, at step 1014, the ad server 502 can check the conditions that are associated with the two or more ad creatives against the list of mobile apps. At step 1016, the ad server 502 sends to the mobile device 504 the ad creative whose associated condition has been met.

If a list of mobile apps had not been sent by the requesting mobile device, at step 1012, the ad server 502 checks if the advertiser that sent the set of ad creatives had also sent JavaScript condition statement(s) for the set of ad creatives. At step 1012, the ad server 502 checks if JavaScript condition statement(s) have been submitted. If JavaScript condition statement has not been supplied with the set of ad creatives, the ad server 502, at step 1014, generates the JavaScript condition statement that expresses the condition entered by the advertiser by way of a user interface, as shown for example in FIG. 13. At step 1018, the ad server 502 sends a response for the ad request, including the set of two or more ad creatives and the associated condition code for each ad creative.

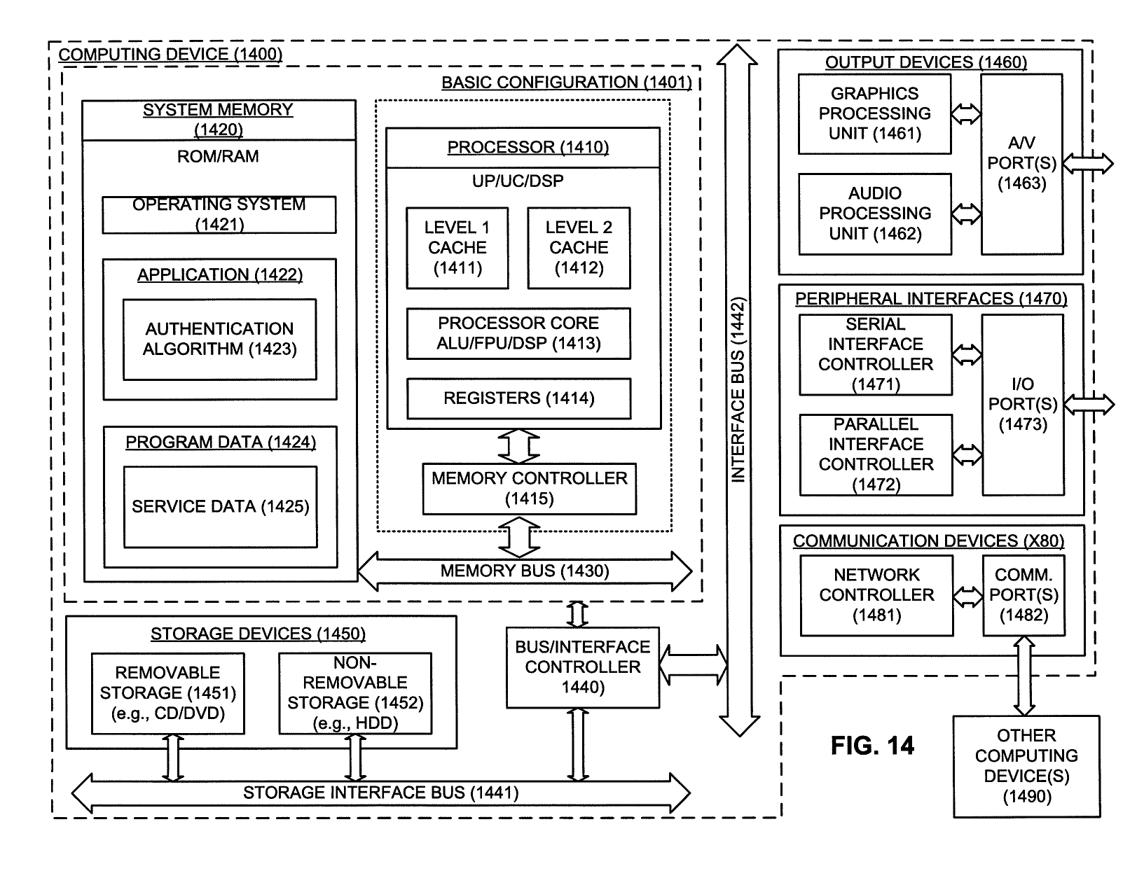

FIG. 14 is a block diagram illustrating an example computing device 1400 that is arranged as an ad server 502 in accordance with the present disclosure. In a very basic configuration 1401, computing device 1400 typically includes one or more processors 1410 and system memory 1420. A memory bus 1430 can be used for communicating between the processor 1410 and the system memory 1420.

Depending on the desired configuration, processor 1410 can be of any type including but not limited to a microprocessor (μP), a microcontroller (μC), a digital signal processor (DSP), or any combination thereof. Processor 1410 can include one more levels of caching, such as a level one cache 1411 and a level two cache 1412, a processor core 1413, and registers 1414. The processor core 1413 can include an arithmetic logic unit (ALU), a floating point unit (FPU), a digital signal processing core (DSP Core), or any combination thereof. A memory controller 1415 can also be used with the processor 1410, or in some implementations the memory controller 1415 can be an internal part of the processor 1410.

Depending on the desired configuration, the system memory 1420 can be of any type including but not limited to volatile memory (such as RAM), non-volatile memory (such as ROM, flash memory, etc.) or any combination thereof. System memory 1420 typically includes an operating system 1421, one or more applications 1422, and program data 1424. Application 1422 includes an ad selection process 1423 that is arranged to conduct an auction in order to select an ad, or set of ads associated with an advertiser. In some embodiments, application 1422 can be arranged to operate with program data 1424 on an operating system 1421 in order to generate condition code for controlling the order that landing pages will be considered, or for determining an ad from a set of ads that is to be shown. This described basic configuration is illustrated in FIG. 14 by those components within dashed line 1401.

Computing device 1400 can have additional features or functionality, and additional interfaces to facilitate communications between the basic configuration 1401 and any required devices and interfaces. For example, a bus/interface controller 1440 can be used to facilitate communications between the basic configuration 1401 and one or more data storage devices 1450 via a storage interface bus 1441. The data storage devices 1450 can be removable storage devices 1451, non-removable storage devices 1452, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 1420, removable storage 1451 and non-removable storage 1452 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1400. Any such computer storage media can be part of device 1400.

Computing device 1400 can also include an interface bus 1442 for facilitating communication from various interface devices (e.g., output interfaces, peripheral interfaces, and communication interfaces) to the basic configuration 1401 via the bus/interface controller 1440. Example output devices 1460 include a graphics processing unit 1461 and an audio processing unit 1462, which can be configured to communicate to various external devices such as a display or speakers via one or more A/V ports 1463. Example peripheral interfaces 1470 include a serial interface controller 1471 or a parallel interface controller 1472, which can be configured to communicate with external devices such as input devices (e.g., keyboard, mouse, pen, voice input device, touch input device, etc.) or other peripheral devices (e.g., printer, scanner, etc.) via one or more I/O ports 1473. An example communication device 1480 includes a network controller 1481, which can be arranged to facilitate communications with one or more other computing devices 1490 over a network communication via one or more communication ports 1482. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 1400 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1400 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method, comprising:
sending a request to a server computer;
receiving a content coupled with a set of alternative documents associated with the content and a condition code script specifying a condition for selecting from the set of alternative documents;
requesting a document;
opening a first document among the set of alternative documents when the condition specified in the condition code is met,
opening another document different from the first document when the condition is not met; and
showing the first or another document in accordance with the results of the condition.

2. The method of claim 1, wherein the request is a request for an ad, and the set of alternative documents received as a response are an ordered sequence of landing pages associated with the ad,
wherein the first document is the landing page for an advertiser's mobile application, the another document is a landing page for an advertiser's Web site, and the condition is for checking that the advertiser's mobile application can be opened on the mobile device, such that
the landing page for an advertiser's mobile application contained locally in the mobile device is opened when the condition is met, and
the landing page for an advertiser's Web site is opened in a Web browser of the mobile device when the condition is not met.

3. The method of claim 1, wherein the request is a request for an ad, and the set of alternative documents received as a response is an ordered sequence of landing pages associated with the ad, and one of the landing pages is a mobile application store,
wherein the first document is the landing page for an advertiser's mobile application, the another document is the landing page of the mobile application store, and the condition is for checking that the advertiser's mobile application can be opened on the mobile device,
wherein parameters associated with the ad are stored in a memory of the mobile device, such that
the landing page for the advertiser's mobile application contained locally in the mobile device is opened when the condition that the advertiser's mobile application can be opened is met,
the landing page for the mobile application store is opened in a viewer of the mobile device enabling downloading of the advertiser's mobile application when checking the condition results in that the advertiser's mobile application can not be opened, and
upon opening the downloaded advertiser's mobile application, the stored parameters are retrieved from the memory by the advertiser's mobile application.

4. A method, comprising:
sending a request to a server computer;
receiving as a response to the request, two or more contents together with condition code script for the respective contents, the condition code script specifying a set of apps as a condition for showing a respective content;
sending a request to execute the condition code script for the respective content, execution of the condition code script including determining a condition that the specified set of apps exist on the mobile device;
repeating the sending step until a condition that the set of apps exists is met; and
showing the content whose condition is met.

5. The method of claim 4,
wherein the request is a request for an ad, and a set of two or more ads are received as the response,
wherein the condition code script is a script for determining that a set of mobile apps are present or absent in the mobile device as a condition for showing a respective ad, the method further comprising
sending a request to check the condition associated with a respective ad that a set of mobile apps are present or absent in the mobile device, and
showing the ad whose condition specifying presence or absence of a set of mobile apps that is met.

6. A method, comprising:
receiving a content and an ordered sequence of document addresses;
storing the content in association with the ordered sequence of document addresses in a content database;
receiving a request for a content from a mobile device;
selecting a content from the content database, the selected content being the received content;
generating a condition script, in accordance with the ordered sequence of document addresses, to be handled by a script handler on the mobile device; and
sending to the mobile device, as a response to the request for content, the selected content and the condition script .

7. The method of claim 6, wherein
the step of receiving a content comprises receiving an ad and associated ordered sequence of landing page addresses, and
the step of generating a condition script comprises generating a JavaScript condition code specifying a condition for checking in order of the sequence, which document at the corresponding document address can be opened, and for showing the document that is opened.

8. A method, comprising:
receiving a group of two or more contents and respective conditions associated with the contents, the condition being a condition for showing a respective content;
storing the group of two or more contents and respective conditions in a content database;
receiving a request for a content from a mobile device;
selecting a content group from the content database, the content group being the received two or more contents; and
generating condition scripts, in accordance with the conditions associated with the group of two or more contents, to be handled by a script handler on the mobile device.

9. The method of claim 8,
wherein the step of receiving a group of two or more contents comprises receiving a group of two or more ads and associated conditions for showing the respective ads on the mobile device,
wherein the step of generating condition scripts, includes generating a condition script for determining that a predefined set of mobile apps are present as a first condition for showing a first ad of the group of ads, generating a condition script for determining that a different predetermined set of mobile apps are present as a second condition for showing a second ad of the group of ads, and generating code for showing an ad whose condition is met,
the method further comprising
sending a response that includes the group of two or more contents and the associated condition scripts.

10. The method of claim 8,
wherein the step of receiving a request for a content includes receiving a list of mobile apps contained in the mobile device,
wherein a condition script for a respective content includes a condition that a set of apps be present or absent in the mobile device,
the method further comprising
executing the condition script for a respective content against the list of mobile apps;
repeating the executing step for a next respective content in order until a condition that a set of apps be present or absent is met; and
sending a response comprising a content for the associated condition that is met.

11. A mobile device comprising:
a processor;
a communications circuit for external communication;
a memory;
and
a display device;
the processor processing a mobile application and using services of an operating system, the mobile application containing a content processing component;
the communications circuit sending a request for a content from the mobile application to a server computer and receiving a content coupled with a condition code for selecting among a plurality of alternative documents associated with the received content;
the content processing component requesting a document associated with the received content, sending a request to execute the condition code to open a document associated with the virtual content whose condition specified in the condition code is met, and to open another document different from the first document when the condition is not met; and
the display device showing the document in accordance with the results of executing the condition code.

12. A mobile device, comprising:
a processor;
a communications circuit sending a request for a virtual content to a server computer;
a memory storing one or more mobile applications; and
a display device,
the processor executing an operating system capable of reporting a list of mobile applications stored in the memory,
the processor processing a mobile application and using services of an operating system, the mobile application containing a content processing component,
the content processing component receiving as a response to the request, a group of two or more contents together with condition code scripts for respective contents and sending a request to the operating system of the mobile device to execute a condition code of the received condition codes, selecting a virtual content whose condition code is met, and
the display device showing the selected virtual content.

13. A server computer in communication with a content database system, comprising:
a processor including a content selection component; and
a memory,
the processor receiving a content and an ordered sequence of document addresses and storing the content in association with the sequence of document addresses in the content database;
the processor receiving a request for a content from a mobile device, selecting a content from the content database, the selected content being the content received, generating a condition script, in accordance with the ordered sequence of document addresses, to be handled by a script handler on the mobile device, and sending to the mobile device, as a response to the request for content, the selected content and the condition script.

14. A server computer in communication with a content database system, comprising:
a processor including content selection component; and
a memory,
the processor receiving a group of two or more contents and corresponding conditions associated with the virtual contents, the condition being a condition for showing a respective content of the group of contents, and storing the group of two or more contents and respective conditions in the content database;
the processor receiving a request for a content from a mobile device;
selecting a content group from the content database, the content group being the received two or more contents, and generating condition scripts, in accordance with the conditions associated with the group of two or more contents, to be handled by a script handler on the mobile device.

15. The server claim 14, wherein the processor receives a list of mobile apps contained in the mobile device and stores the list of mobile apps in the memory, the processor checks the conditions against the list of mobile apps, and sends a response comprising a content for the associated condition that is met.

16. A computer-readable storage medium storing a computer program, which when executed by a computer performs steps of:
receiving a content coupled with a condition code specifying a condition;
requesting that the computer execute the condition code;
requesting that the computer open a document associated with the content when condition specified in the condition code is met,
requesting that the computer open another document different from the first document when the condition is not met; and
showing the first document or the another document in accordance with the results of the condition.

17. A computer-readable storage medium storing a computer program, which when executed by a computer performs steps of:
sending a request for a content to a server computer;
receiving as a response to the request, a group of two or more contents together with corresponding condition code for respective contents;
requesting that the computer execute in the grouped order condition codes of the received condition codes;
selecting a content whose respective condition code is met; and
showing the selected content.
